(19) United States
(12) Patent Application Publication
(10) Pub. No.: US 2020/0202245 A1
(43) Pub. Date: Jun. 25, 2020

(54) A PROBABILISTIC DATA CLASSIFIER SYSTEM AND METHOD THEREOF

(71) Applicant: Stratyfy, Inc., New York, NY (US)

(72) Inventors: Dmitry LESNIK, Wiesbaden (DE); Stas CHERKASSKY, Haifa (IL); Michael CHERKASSKY, New York, NY (US); Laura KORNHAUSER, New York, NY (US)

(73) Assignee: Stratyfy, Inc., New York, NY (US)

(21) Appl. No.: 16/644,243

(22) PCT Filed: Oct. 14, 2018
(86) PCT No.: PCT/IL2018/051103

§ 371 Date: Mar. 4, 2020

Related U.S. Application Data
(60) Provisional application No. 62/554,152, filed on Sep. 5, 2017.

(51) Int. Cl. G06N 7/00; G06N 5/02; G06N 20/00

(52) U.S. Cl. CPC G06N 7/005; G06N 20/00; G06N 5/027

(57) ABSTRACT

Decision engines are deployed in a variety of fields, from medical diagnostics to financial applications such as lending. Typically, solutions involve rule engines or artificial intelligence (AI) to assist in making a decision based on transactional data. However, rules can be complicated to maintain and conflicting, and AI does not offer transparency which is required for example, in many applications of the financial industry. The proposed solution discussed herein includes a rule engine which processes transactions based on weighted rules. The system is trained from a training transaction set. In some embodiments, the system may mine the training transaction set for rules, while in other embodiments the rules may be predefined and assigned weights by the system.

### CROSS REFERENCE TO RELATED APPLICATIONS

This application claims priority under 35 U.S.C. § 371 to the International Application No. PCT/IL2018/051103, filed Oct. 14, 2018, now pending, which claims the benefit of U.S. Provisional Application No. 62/554,152 filed on Sep. 5, 2017, the contents of which are hereby incorporated by reference.

### TECHNICAL FIELD

The disclosure generally relates to data classification systems and particularly to probabilistic data classification systems.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Similarly, issues identified with respect to one or more approaches should not assume to have been recognized in any prior art on the basis of this section, unless otherwise indicated.

As an increasing number of transactions occur online, so does the need for correctly identifying outcomes for these transactions increase. A transaction may be a request for a loan, a request to process an ecommerce order, a decision at what interest rate to grant a loan, determine if a transaction is fraudulent, medical diagnostics, etc. Typically, these are solved either by a rule engine, or increasingly machine learning systems (known as AI—artificial intelligence). Rule engines tend to become complicated very fast, leading to conflicting rules. Machine learning may provide answers to such transactions with increasingly better predictive capabilities, and even at lower computational cost, however they are often a “black box”, in the sense that these solutions do not provide how or why they arrived at the decision which they did, merely they provide the end result. Therefore, rules may be necessary in some industries, where transparency may be required by regulations, for example. As each of these methodologies has its drawbacks in certain situations, it would be advantageous to provide a solution which overcomes at least some of the deficiencies of the prior art.

### BRIEF DESCRIPTION OF THE DRAWINGS

The foregoing and other objects, features and advantages will become apparent and more readily appreciated from the following detailed description taken in conjunction with the accompanying drawings, in which:

FIG. 1—is a schematic illustration of a probabilistic data classifier system implemented according to an embodiment.

FIG. 2—is a flowchart of a computerized method for rule based machine learning of a probabilistic data classifier system, implemented in accordance with an embodiment.

FIG. 3—is a schematic illustration of training a probabilistic data classifier (PDC) system, implemented in accordance with an embodiment.

FIG. 4—is a flowchart of a computerized method of training a probabilistic data classifier (PDC) system, implemented in accordance with an embodiment.

FIG. 5—is a schematic illustration of a PDC system implemented in a network environment, operating in accordance with an embodiment.

FIG. 6—is a flowchart of a computerized method for generating predicted outcomes using a PDC system, implemented in accordance with an embodiment.

FIG. 7—is a flowchart of a computerized method for determining impact and increasing transparency in a PDC system, implemented in accordance with an embodiment.

### DETAILED DESCRIPTION

Below, exemplary embodiments will be described in detail with reference to accompanying drawings so as to be easily realized by a person having ordinary knowledge in the art. The exemplary embodiments may be embodied in various forms without being limited to the exemplary embodiments set forth herein. Descriptions of well-known parts are omitted for clarity, and like reference numerals refer to like elements throughout.

It is important to note that the embodiments disclosed herein are only examples of the many advantageous uses of the innovative teachings herein. In general, statements made in the specification of the present application do not necessarily limit any of the various claims. Moreover, some statements may apply to some inventive features but not to others. In general, unless otherwise indicated, singular elements may be in plural and vice versa with no loss of generality.

Decision engines are deployed in a variety of fields, from medical diagnostics to financial applications such as lending. Typically, solutions involve rule engines or artificial intelligence (AI) to assist in making a decision based on transactional data. However, rules can be complicated to maintain and conflicting, and AI does not offer transparency which is required for example, in many applications of the financial industry. The proposed solution discussed herein includes a rule engine which processes transactions based on weighted rules. The system is trained from a training transaction set. In some embodiments, the system may mine the training transaction set for rules, while in other embodiments the rules may be predefined and assigned weights by the system.

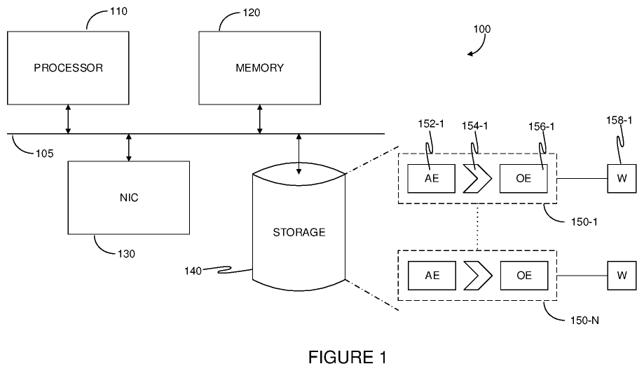

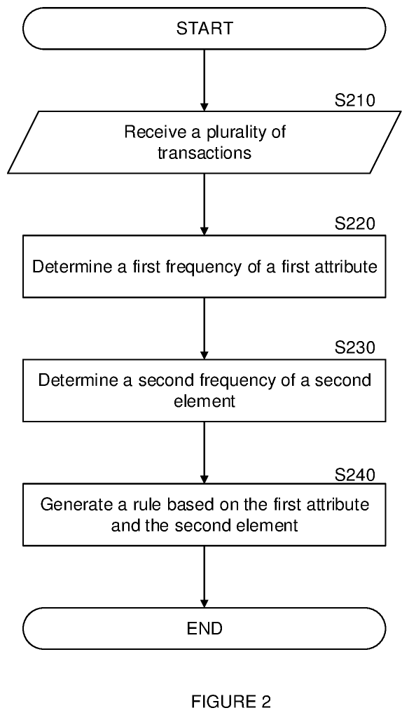

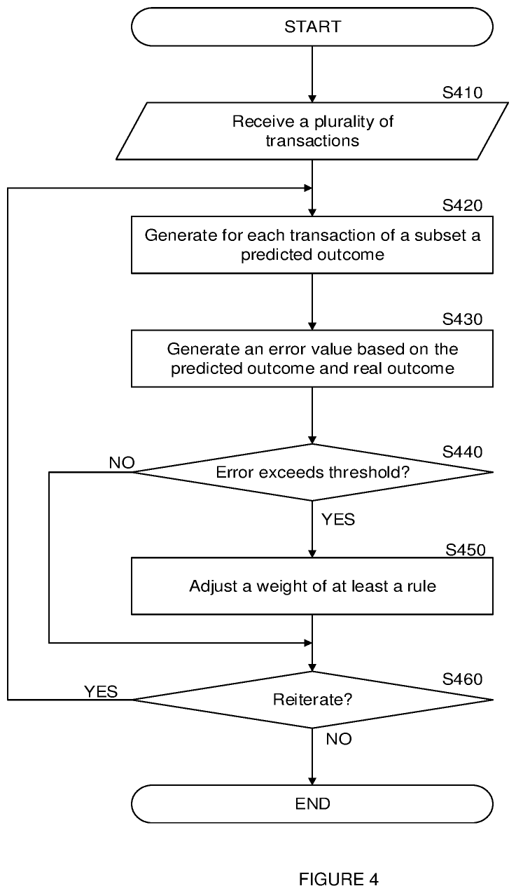

FIG. 1 is an exemplary and non-limiting schematic illustration of a probabilistic data classifier system 100 implemented according to an embodiment. The system 100 includes at least one processor 110 (or processing element), for example, a central processing unit (CPU). In an embodiment, the processing element 110 may be, or be a component of, a larger processing unit implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information. The processing element 110 is coupled via a bus 105 to a memory 120. The memory 120 may include a memory portion that contains instructions that when executed by the processing element 110 performs the method described in more detail herein. The memory 120 may be further used as a working scratch pad for the processing element 110, a temporary storage, and others, as the case may be. The memory 120 may be a volatile memory such as, but not limited to random access memory (RAM), or non-volatile memory (NVM), such as, but not limited to, Flash memory. The processing element 110 may be coupled to a network interface controller (NIC) 130 for providing connectivity to other components, for example over a network. The processing element 110 may be further coupled with a storage 140. Storage 140 may be used for the purpose of holding a copy of the method executed in accordance with the disclosed technique. The storage 140 may include a plurality of rules 150-1 through 150-N, for example, for classifying transactions in a transactional database. Classifying transactions may include generating a predicted outcome of the transaction. Each rule 150 includes a plurality of elements, such as one or more attribute elements 152, which may each correspond to a data field of a transaction, and one or more output elements 156. A rule 150 further includes a condition (or relation) 154. A condition may be, for example, an “If-Then” condition, or any logical expression, including connectives such as or, xor, and, etc. In the exemplary embodiments discussed herein, each rule is further associated with a weight value 158. The weight values may be static, dynamic, or adaptive. A static weight is predetermined and remains constant. Dynamic values are forcefully changed. Adaptive weights are changed in response to a learning process, and example of which is discussed in more detail with respect to FIG. 2 and FIG. 4 below. In some embodiments, rules may have a single element, for example in indicating that a certain attribute is always “true” (or false, depending on the implemented logic). Applying a rule may yield an output, which in an embodiment is a value representing the probability that the rule is “true” (or “false”) for the rule. The processing element 110 and/or the memory 120 may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described in further detail herein.

FIG. 2 is a non-limiting exemplary flowchart of a computerized method for rule based machine learning of a probabilistic data classifier system, implemented in accordance with an embodiment. Rule based machine learning may also be known as rule mining. This flowchart is one exemplary method of the same, though other methods may be used without departing from the scope of this disclosure.

In S210 a plurality of transactions are received. A transaction may include a plurality of attribute elements, and one or more output elements. In an embodiment the transactions may be received from a transactional database.

In S220 a first frequency of a first attribute is determined, based on the number of times the first attribute appears in the plurality of transactions. For example, in a transactional database containing therein purchases from a retail store, the first attribute may be “jacket”. Other attributes may be “pants”, “sunglasses”, “hat”, and “belt”. The number of times “jacket” appears in the transactions is indicative of its frequency.

In S230 a second frequency of a second element is determined, in response to the first frequency exceeding a first threshold. For example, if the attribute “jacket” exceeds a threshold of 10% (i.e. appears in more than 10% of transactions), then a frequency of at least another element is determined, with which “jacket” may be correlated. The second element may be another attribute, or in some embodiments, an output element. In certain embodiments there may be a plurality of second elements. An output element may be, for example, the “then” part of the “If-Then” clause. For example, a rule may be

if “jacket”→“belt”

meaning that if a customer purchased a jacket, then they are likely to purchase a belt as well. In this example, the attribute “belt” is the output element.

In S240 a rule is generated based on the first attribute and the second element, in response to the second frequency exceeding a second threshold. The second threshold may be determined based on the number of transactions of the first frequency. In the above example, if “jacket” appears in over 10% (first threshold) of transactions, and of those transactions if “belt” appears in over 30% (second threshold), a rule may be generated. In some embodiments, the PDC system may allow manual addition of rules as well. In certain embodiments, the rules may have been predefined (manually or otherwise) and the PDC system will assign weights to them, as explained in more detail with respect to FIG. 4.

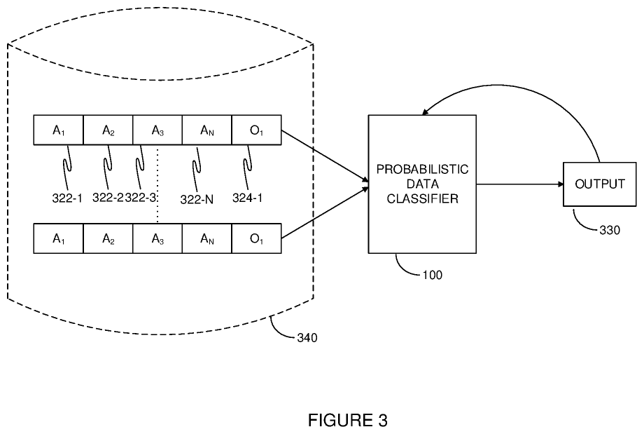

FIG. 3 is a non-limiting exemplary schematic illustration of training a probabilistic data classifier (PDC) system 100, implemented in accordance with an embodiment. A PDC system 100 receives a plurality of training transactions 310-1 through 310-M. In some embodiments, the plurality of training transactions 310 through 310-M are a subset of a full training transaction set, which includes an additional subset of training transactions 310-L, such that ‘L’ is larger than ‘M’. Each training transaction 310 includes a plurality of attribute elements and one or more output elements. For example, training transaction 310-1 includes ‘N’ elements, 322-1, 322-2, 322-3, 322-N, and an output element 324-1. In some exemplary embodiments, the attribute elements 322-1 through 322-N may be provided for training the PDC system, without providing the output elements of a transaction. The PDC system may be preloaded with rules, or generate rules, for example by the method discussed in more detail above. In some embodiments, the PDC system may be preloaded with a first set of rules, and may then generate another set of rules. Weights are assigned to the preloaded rules and to the generated another set of rules, for example according to the methods discussed in more detail herein. The PDC system generates a predicted output 330 for each training transaction it is provided with. In some embodiments, the PDC system may generate a predicted output for a portion of the training transactions. Such a portion may be predetermined, randomly selected, or selected in accordance with one or more rules. For example, only transactions where an attribute has a certain value would be used for generating a prediction, is one such rule for selecting a training transaction. The generated predicted output may then be compared with the real output element of the transaction. An objective function may be determined, to minimize certain attributes and/or maximize others. For example, the objective function may be determining an error, or error function, which may be generated based on one or more generated predicted outputs and corresponding real outputs. In order to minimize the error (i.e. optimize the objective function), the PDC system may adjust the weight of one or more rules. In some embodiments the PDC system 100 may further associate a price of misclassification. For example, when determining a medical diagnostic, it may be more important to eliminate false negatives, rather than false positives. Therefore, the objective function may be defined such that if a system prediction was determined to be a false negative, the PDC system would penalize the corresponding rule(s) more than it would had the same (or different) rule(s) generated a false positive. The training transaction set may be provided to the PDC system 100 in a number of iterations, and the entire training transaction set may be run through the PDC system 100 multiple epochs until the error is minimized below a certain threshold. In an embodiment, the training transactions 310 may be stored on a transactional database 340.

FIG. 4 is a non-limiting exemplary flowchart of a computerized method of training a probabilistic data classifier (PDC) system, implemented in accordance with an embodiment.

In S410 a plurality of training transaction are received. The training transactions may be records (sometimes referred to as cases) from a transactional database, for example. Each training transaction includes one or more attributes, and one or more output elements. An output element may be, for example, the output of a transaction. For example, an ecommerce transaction may include item SKUs, price per SKU, total price in cart, geolocation of shopper, demographic information, etc. The outcome of such a transaction may be, for example, abandonment of cart, denied transaction (because of fraud suspicion, denied credit, etc), transaction allowed, and the like.

In S420 the PDC system generates a predicted outcome for each transaction of at least a subset of the plurality of training transactions. The prediction may be based on one or more rules of the PDC system. Each rule includes an adjustable weight. In some embodiments, a first subset may be used for the purpose of training the PDC system, while a second subset is used for cross validation.

In S430 an error value is generated based on a generated predicted outcome and a corresponding real outcome of the transaction. In some embodiments, a plurality of error values are generated. In certain embodiments, an error function is generated. A threshold may be defined to determine what is an acceptable error (i.e. what is considered a good prediction capability). The lower the error is, the better the PDC system is able to perform classification of transactions.

In S440 a check is performed to determine if the error exceeds a first threshold. If ‘no’ execution continues at S460, otherwise execution continues at S450.

In S450 a weight of at least one rule of the PDC is adjusted. In some embodiments, the error may be generated again to determine if the adjusted weight improved the error.

In S460 a check is performed to determine if the process of training should be reiterated. A reiteration is running all, or a portion, of the training transaction set through the PDC system and determining if weights of rules should be adjusted. If ‘yes’, execution continues at S420, otherwise execution terminates.

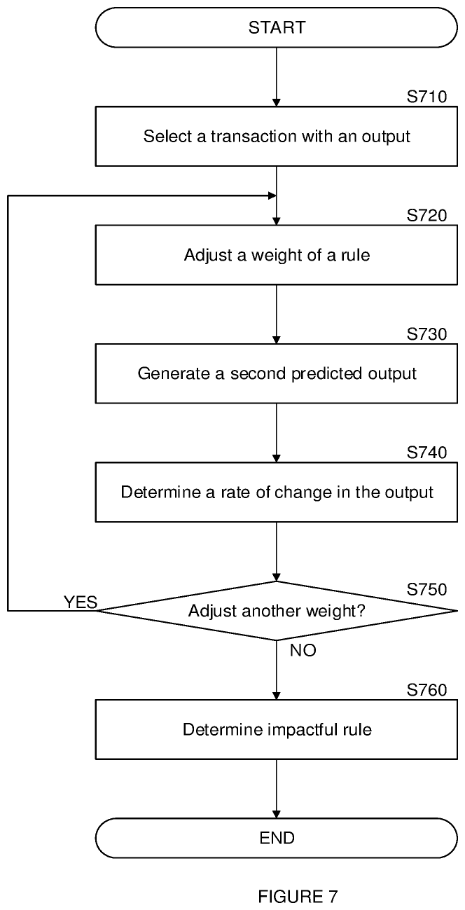

In some embodiments, a second subset of training transactions not used for training may be used for cross validation. The second subset of training transaction is provided to the PDC system 100, which generates predicted outcomes and error values based on the predicted outcomes and the corresponding real outcomes. In some embodiments, an error function generated based on training the PDC system with the first subset of training transactions may be below the first threshold, while an error function generated based on providing the PDC system with the second subset of training transactions may exceed the first threshold. This may happen, for example, if there is a bias in the data of the first subset of training transactions. In such embodiments, the PDC system may send a notification to a user thereof, or for example, enlarge the first subset by removing transactions from the second subset and associating them with the first subset, then training the PDC system with the updated first subset. In a more generalized form, the PDC system may perform k-fold cross validation, where ‘k’ is an integer number equal or less than the number of transactions available for training. For example, the PDC system may select a first group of transactions for training and a second set for cross validation. The PDC system will generate weights and perform adjustments according to the training set. The first group is then split again to a secondary training group and a secondary validation. This process can be iterated ‘k’ times, each training resulting in values foe weights of the rules. A weight may then be determined, from the plurality of results relating to a specific rule, for example by averaging the results. A PDC system 100 is considered trained when the error is below the first threshold. In some embodiments, if the weight of a rule is within a second threshold, the system may discard the rule. In another example, the system may determine the impact of a rule (discussed in more detail in FIG. 7). If the impact is below a threshold, then the rule may be discarded.

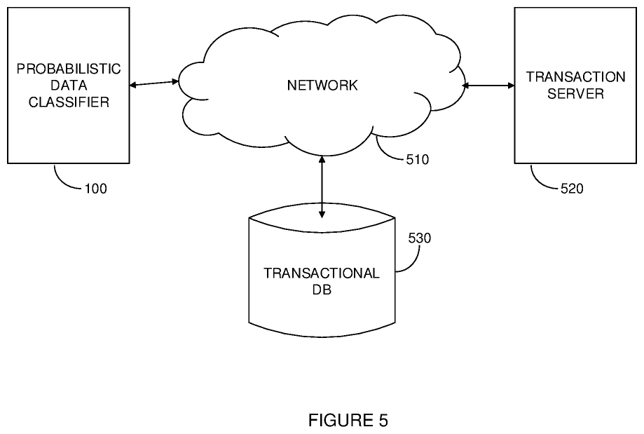

FIG. 5 is a non-limiting exemplary schematic illustration of a PDC system 100 implemented in a network environment, operating in accordance with an embodiment. The PDC system 100 is connected, for example via NIC 130 to a network 510. In an embodiment, the network 510 may be configured to provide connectivity of various sorts, as may be necessary, including but not limited to, wired and/or wireless connectivity, including, for example, local area network (LAN), wide area network (WAN), metro area network (MAN), worldwide web (WWW), Internet, and any combination thereof, as well as cellular connectivity. The network 510 further provides connectivity for a transactional database 520 and a transaction server 530. The transaction server generates transactions, for example based on interaction with user devices (not shown, which may also be connected to the network 510). The transaction server 530 stores the generated transactions in the transactional database 520. In some embodiments, the transaction server collects data to include in the transaction. The server may provide the transaction to the PDC system 100 in order to generate an outcome which the server may then implement. For example, the transaction server 520 may provide to the PDC system 100 a transaction indicative of a request for a loan. The PDC system 100 will then generate an outcome, such as “approval”, “denial”, etc. respective of the request for the loan, which the transaction server will then implement according to instructions stored thereon. In some embodiments, the PDC system 100, the transaction server 530 and/or the transactional DB 530 may be implemented all on one or more machines in a networked environment.

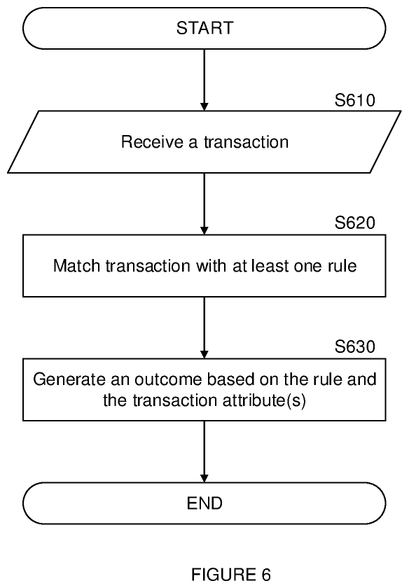

FIG. 6 is a non-limiting exemplary flowchart of a computerized method for generating predicted outcomes using a PDC system, implemented in accordance with an embodiment.

In S610 a transaction is received by a PDC system. The transaction includes a plurality of attributes. In an embodiment, the transaction is generated by a transaction server, based on one or more interactions the transaction server handles with a user device communicatively connected thereto. The PDC system includes a plurality of rules, each rule including at least: an attribute, another element (such as another attribute, or an outcome), and a relation between the attribute and the another element. The relation may be, for example, an “If-Then” relation.

In S620 the transaction is matched with at least one rule of the plurality of rules. A transaction is matched to a rule if the weight of the rule is non-zero, and an element of the rule corresponds to an attribute. and/or value of an attribute, of the transaction. In some embodiments, a transaction is matched to a plurality of rules. In prior art systems, this may result in a conflict. An advantage offered by a weighted-rule based system is that rules do not conflict with each other, instead they can be viewed as competing. In S630 an outcome is generated based on the implementation of the matched rule with the highest weight, on the transaction.

FIG. 7 is a non-limiting exemplary flowchart of a computerized method for determining impact and increasing transparency in a PDC system, implemented in accordance with an embodiment.

In S710 a transaction is selected, the transaction having been processed by the PDC system, and for which the PDC system generated a first output. A transaction is selected to determine what rule(s) had an increased effect on the transaction. By allowing a user to know what rule(s) determined an outcome for a given transaction, the system increases transparency, which may be crucial for example for financial industries which are regulated and must be able to show compliance.

In S720 a weight of a rule is adjusted. In an embodiment, the system may randomly select a rule, or as another example, select a rule which has a high probability (e.g. between 0.9 and 1) or a very low probability (between 0 and 0.01).

In S730 the transaction is processed by the PDC system after the weight is adjusted, to generate a second predicted output.

In S740 a rate of change in the objective function of rule for which the weight was adjusted is determined, between the first output, and the second predicted output.

In S750 a check is performed to determine if another weight adjustment should be performed, for the same rule, for another rule, or for a combination thereof. If ‘yes’ execution continues at S720, otherwise execution continues a S750.

In S760 the PDC system determines which rule had the largest impact on the output of the transaction, based on the determined rate of change. A higher rate of change is indicative of a stronger impact. The system may generate a notification to a user to indicate what the rule is. In some embodiments, a plurality of rules may be adjusted simultaneously. In some embodiments, an impact may be determined on a specific case. In certain other embodiments, an impact may be determined on a plurality of transactions. For example, an impact may be determined on each of a plurality of training transactions. The PDC system 100 may remove a rule if the average impact is below a certain threshold, or as another example if for each transaction the impact of the rule is below a certain threshold.

In the above exemplary embodiments, ‘L’, ‘M’, and ‘N’ are integer values having each a value of ‘1’ or greater.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

1. A method for probabilistic data classification in a rule engine, the method comprising:
receiving a training data set, the data set comprising a plurality of training transactions, each transaction comprising: a plurality of attribute elements, and a real output element;
assigning a weight value to each of a plurality of rules of the rule engine, each rule comprising an attribute element, and one or more rules further comprise: another element, and a relation between the attribute element and the another element;
receiving from the rule engine a predicted output for each case of at least a first portion of the plurality of training transactions, in response to providing the at least a first portion of the plurality of training transactions to the rule engine;
determining an objective function based on a predicted output and a corresponding real output;
adjusting the weight value of at least a rule of the plurality of rules to minimize or maximize the objective function
receiving from the rule engine a predicted output for each case of a second portion of the plurality of training cases;
determining an objective function based on a predicted output and a corresponding real output; and
sending a notification to indicate that the rule engine is operative, in response to the objective function reaching a threshold value.

2. (canceled)

3. The method of claim 1, further comprising:
sending a notification to indicate that the rule engine is inoperative, in response to the objective function outside of the threshold value.

4. The method of claim 1, wherein the objective function is outside of the threshold value, further comprising:
removing one or more transactions from the second portion;
associating the removed one or more transactions with the first portion of training transactions; and
providing the updated first portion of training transactions to the rule engine.

5. The method of claim 1, wherein the another element is: an attribute, or an output.

6. The method of claim 1, further comprising:
removing a rule from the plurality of rules, in response to the weight of the rule being within a threshold.

7. The method of claim 1, further comprising:
determining the impact of a rule;
removing the rule from the plurality of rules, in response to the impact being below a threshold.

8. The method of claim 7, wherein determining the impact further comprises:
adjusting the weight of the rule;
determining a rate of change of the output of a transaction based on a plurality of weights of the rule; and
generating an impact value, based on the rate of change.

9. The method of claim 1, wherein the weight value is any of: static, dynamic, or adaptive.

10. The method of claim 1, further comprising:
generating a rule based on the plurality of training transactions.

11. The method of claim 10, wherein generating a rule further comprises:
determining a first frequency of a first attribute in the plurality of training transactions;
determining a second frequency of a second attribute, in response to the first frequency exceeding a first threshold;
generating a rule based on the first attribute and the second attribute, in response to the second frequency exceeding a second threshold.

12. The method of claim 10, further comprising:
receiving a rule as an input from a user.

13. The method of claim 1, wherein one or more weights are adjusted until the error value is below a first threshold.

14. The method of claim 1, further comprising:
receiving a new transaction;
applying one or more rules of the plurality of rules to the transaction; and
generating an outcome based on a portion of the rules of the one or more rules.

15. A probabilistic data classification rule engine system, the system comprising:
a processing circuitry; and
a memory, the memory containing instructions that, when executed by the processing circuitry, configure the system to:
receive a training data set, the data set comprising a plurality of training transactions, each transaction comprising: a plurality of attribute elements, and a real output element;
assign a weight value to each of a plurality of rules of the rule engine, each rule comprising an attribute element, and one or more rules further comprise: another element, and a relation between the attribute element and the another element;
generate a predicted output for each case of at least a first portion of the plurality of training transactions, in response to providing the at least a first portion of the plurality of training transactions to the rule engine;
determine an objective function based on a first predicted output and a corresponding first real output;
adjust the weight value of at least a rule of the plurality of rules to minimize or maximize the objective function;
generate a predicted output for each case of a second portion of the plurality of training cases;
determine an objective function based on a predicted output and a corresponding real output; and
send a notification to indicate that the rule engine is operative, in response to the objective function reaching a threshold value.

16. (canceled)

17. The system of claim 15, wherein the system is further configured to:
send a notification to indicate that the rule engine is inoperative, in response to the objective function outside of the threshold value.

18. The system of claim 15, wherein the objective function is outside of the threshold value, and the system is further configured to:
remove one or more transactions from the second portion;
associate the removed one or more transactions with the first portion of training transactions; and
provide the updated first portion of training transactions to the rule engine.

19. The system of claim 15, wherein the another element is: an attribute, or an output.

20. The system of claim 15, wherein the system is further configured to:
remove a rule from the plurality of rules, in response to the weight of the rule being within a threshold.

21. The system of claim 15, wherein the system is further configured to:
determine the impact of a rule;
remove the rule from the plurality of rules, in response to the impact being below a threshold.

22. The system of claim 21, wherein the system is further configured to determine the impact by:
adjusting the weight of the rule;
determining a rate of change of the output of a transaction based on a plurality of weights of the rule; and
generating an impact value, based on the rate of change.

23. The system of claim 15, wherein the weight value is any of: static, dynamic, or adaptive.

24. The system of claim 15, wherein the system is further configured to:
generate a rule based on the plurality of training transactions.

25. The system of claim 24, wherein the system is further configured to generate a rule by:
determining a first frequency of a first attribute in the plurality of training transactions;
determining a second frequency of a second attribute, in response to the first frequency exceeding a first threshold;
generating a rule based on the first attribute and the second attribute, in response to the second frequency exceeding a second threshold.

26. The system of claim 24, wherein the system is further configured to:
receive a rule as an input from a user.

27. The system of claim 15, wherein one or more weights are adjusted until the error value is below a first threshold.

28. The system of claim 15, wherein the system is further configured to:
receive a new transaction;
apply one or more rules of the plurality of rules to the transaction; and
generate an outcome based on a portion of the rules of the one or more rules.
